(19) United States
(12) Patent Application Publication
(10) Pub. No.: US 2026/0254274 A1
(43) Pub. Date: Aug. 27, 2026

(54) WIRELESS CHARGING BASE AND OPERATION METHOD THEREOF

(71) Applicant: ASUSTeK COMPUTER INC., Taipei City (TW)

(72) Inventors: Chia-Jui Shih, Taipei City (TW); Jyun-Hao Jheng, Taipei City (TW); Jyun-Wei Wang, Taipei City (TW); Han-Sheng Chen, Taipei City (TW); Yii-Lin Wu, Taipei City (TW)

(73) Assignee: ASUSTeK COMPUTER INC., Taipei City (TW)

(21) Appl. No.: 19/533,282

(22) Filed: Feb. 8, 2026

(30) Foreign Application Priority Data
Feb. 21, 2025 (TW) 114106486

(51) Int. Cl. H02J 50/10; H02J 50/23; H02J 50/90

(52) U.S. Cl. CPC H02J 50/10; H02J 50/23; H02J 50/90

(57) ABSTRACT

A wireless charging base, including a base body, a controller, a driving assembly, a central track, peripheral tracks, a wireless coil and sensors. The base body includes a central area. The controller and the driving assembly are disposed in the base body and electrically connected. The central track is disposed in the base body and linked to the driving assembly to be rotatably disposed in the central area. The peripheral tracks are disposed in the base body and radially disposed on a periphery of the central area. The central track is driven by the driving assembly to dock with the peripheral track. The wireless coil is disposed in the base body, electrically connected to the controller, and linked to the driving assembly to move along the central track or the peripheral track. The sensors are disposed on the base body at equal intervals and electrically connected to the controller.

### CROSS-REFERENCE TO RELATED APPLICATION

This application claims the priority benefit of Taiwan application serial no. 114106486, filed on Feb. 21, 2025. The entirety of the above-mentioned patent application is hereby incorporated by reference herein and made a part of this specification.

### BACKGROUND

### Technical Field

The disclosure relates to a charging base and an operation method thereof, and in particular to a wireless charging base and an operation method thereof.

### Description of Related Art

Currently, the development of wireless charging is increasingly vigorous. The wireless charging conversion efficiency is increased from 50% to 60% even more than 80% in recent years, causing more and more electronic devices (such as wearable devices, Bluetooth headphones, mobile phones, etc.) equip wireless charging function. Wireless charging bases on the market usually are designed to match coil positions of their own products. Such charging bases specially made for their own products are very difficult to be used by other electronic devices on the market. Wireless charging may not be possible if a center of a coil (such as Rx) in the electronic device is too far offset from a center of a coil (such as Tx) in the wireless charging base.

### SUMMARY

The disclosure provides a wireless charging base and an operation method thereof. The wireless charging base includes a base body, a controller, a driving assembly, a central track, a plurality of peripheral tracks, a wireless coil, and a plurality of sensors. The base body includes a central area. The controller is disposed in the base body. The driving assembly is disposed in the base body and electrically connected to the controller. The central track is disposed in the base body and linked to the driving assembly to be rotatably disposed in the central area of the base body. The peripheral tracks are disposed in the base body and radially disposed on a periphery of the central area. The central track is driven by the driving assembly to dock with one of the peripheral tracks. The wireless coil is disposed in the base body, electrically connected to the controller, and linked to the driving assembly to move along the central track or the one of the peripheral tracks. The sensors are disposed on the base body at an equal interval and electrically connected to the controller.

The disclosure further provides an operation method of a wireless charging base, adapted to supply a power to an electronic device. The operation method includes the following steps. A wireless charging base including a base body, a plurality of sensors located on the base body, and a wireless coil movably disposed in the base body is provided. The base body includes a central area and a plurality of peripheral areas located outside the central area. At least one of the sensors detects being covered when the electronic device is placed on the base body of the wireless charging base. The at least one of the sensors detecting being covered corresponds to at least one of the peripheral areas. The wireless coil is placed in the central area, and a charging test is performed on the electronic device to determine whether an output wattage of the wireless coil exceeds a preset value. The wireless coil starts charging the electronic device in the central area when the wireless coil is located in the central area and the output wattage does not exceed the preset value. The wireless coil is moved to the at least one of the peripheral areas, and the charging test is performed on the electronic device when the wireless coil is located in the central area and the output wattage exceeds the preset value, so as to determine which of the at least one peripheral areas in which the wireless coil is located has the output wattage that does not exceed the preset value. In the peripheral area in which the output wattage of the wireless coil does not exceed the preset value, the wireless coil charges the electronic device.

Based on the above, the central track of the wireless charging base of the disclosure is disposed in the base body and linked to the driving assembly to be rotatably disposed in the central area of the base body. The peripheral tracks are disposed in the base body and radially disposed on a periphery of the central area. The central track is driven by the driving assembly to dock with one of the peripheral tracks. The wireless coil is disposed in the base body, electrically connected to the controller, and linked to the driving assembly to move along the central track or the one of the peripheral tracks. The sensors are disposed on the base body at an equal interval and electrically connected to the controller. Therefore, when the electronic device is placed on the base body of the wireless charging base, a charging test may first be performed on the electronic device in the central area through the wireless coil to determine whether an output wattage of the wireless coil exceeds the preset value. If not, this represents the wireless coil may directly charge in the central area. If yes, this represents the electronic device does not correspond well to the wireless coil, and therefore the wireless coil requires outputting a higher wattage. Then, according to a location of the peripheral area corresponding to the sensor detecting being covered, the controller moves the central track to dock with the corresponding peripheral area, allowing the wireless coil to move to the corresponding peripheral area so that the charging test is performed on the electronic device. Therefore, the wireless charging base of the disclosure is applicable to electronic products of different sizes.

### BRIEF DESCRIPTION OF THE DRAWINGS

FIG. 1 is a schematic top view of a wireless charging base according to an embodiment of the disclosure.

FIG. 2 is a schematic diagram of areas and sensors of a base body of FIG. 1.

FIG. 3 is a schematic flowchart of an operation method of a wireless charging base according to an embodiment of the disclosure.

### DESCRIPTION OF THE EMBODIMENTS

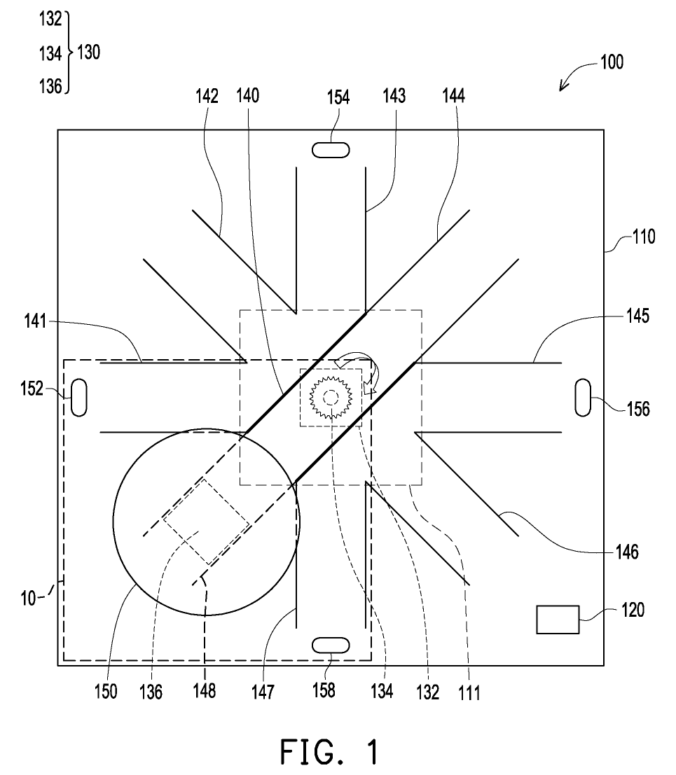

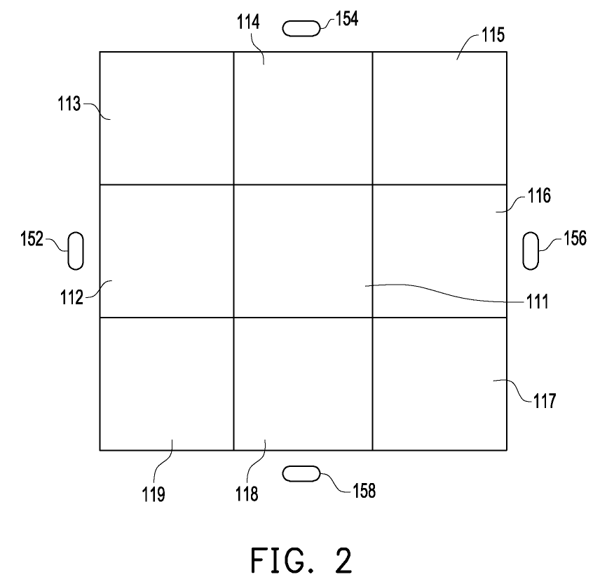

FIG. 1 is a schematic top view of a wireless charging base according to an embodiment of the disclosure. FIG. 2 is a schematic diagram of areas and sensors of a base body of FIG. 1. Referring to FIGS. 1 and 2, a wireless charging base 100 of this embodiment includes a base body 110, a controller 120, a driving assembly 130, a central track 140, a plurality of peripheral tracks 141 to 148, a wireless coil 150, and a plurality of sensors 152, 154, 156, and 158.

The base body 110 includes a central area 111 and a plurality of peripheral areas 112 to 119 located outside the central area 111 (FIG. 2). In this embodiment, a number of the peripheral areas 112 to 119 is eight as an example, and shapes of the peripheral areas 112 to 119 are rectangular as an example, but the number and the shapes of the peripheral areas are not limited thereto.

The controller 120 is disposed in the base body 110. In this embodiment, the controller 120 is a control chip or/and a control circuit. The driving assembly 130 is disposed in the base body 110 and electrically connected to the controller 120.

The central track 140 is disposed in the base body 110 and linked to the driving assembly 130 to be rotatably disposed in the central area 111 of the base body 110. Specifically, in this embodiment, the driving assembly 130 includes a first motor 132 and a gear set 134. The gear set 134 is linked to the first motor 132. The central track 140 is linked to the gear set 134. The central track 140 is rotated through the gear set 134. In this embodiment, the first motor 132 is located under the gear set 134, but the relative position is not limited thereto.

The peripheral tracks 141 to 148 are disposed in the base body 110 and radially disposed on a periphery of the central area 111. The central track 140 is driven by the first motor 132 and the gear set 134 of the driving assembly 130 to dock with one of the peripheral tracks 141 to 148.

In this embodiment, the base body 110 is rectangular. In this embodiment, the number of these peripheral areas 112 to 119 corresponds to the number of these peripheral tracks 141 to 148 is eight. These peripheral tracks 141 to 148 extend toward four corners of the rectangle and four midpoints of four sides. Certainly, in other embodiments, the number of the peripheral areas 112 to 119 may also not correspond to the number of the peripheral tracks 141 to 148.

The wireless coil 150 is disposed in the base body 110, electrically connected to the controller 120, and linked to the driving assembly 130 to move along the central track 140 or one of these peripheral tracks 141 to 148.

In this embodiment, the driving assembly 130 further includes a second motor 136, linked to the wireless coil 150 to drive the wireless coil 150 to move along the central track 140 or one of these peripheral tracks 141 to 148, so that the wireless coil 150 enters one of these peripheral tracks 141 to 148 from the central track 140 or returns to the central track 140 from one of these peripheral tracks 141 to 148. Certainly, a type of the driving assembly 130 is not limited by the above.

These sensors 152, 154, 156, and 158 are disposed on the base body 110 at equal intervals and electrically connected to the controller 120. In this embodiment, each of these sensors 152, 154, 156, and 158 is an optical sensor. These sensors 152, 154, 156, and 158 are disposed on four sides of the rectangle. In other embodiments, these sensors 152, 154, 156, and 158 may also be disposed on four corners of the rectangle. Certainly, positions of the sensors 152, 154, 156, and 158 are not limited thereto.

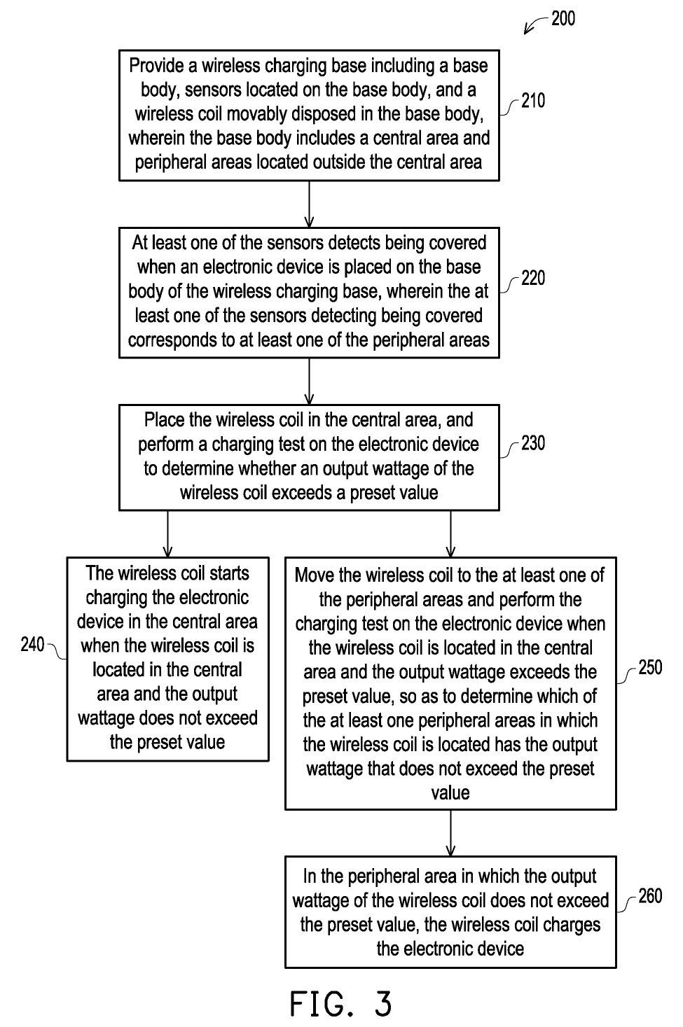

FIG. 3 is a schematic flowchart of an operation method of a wireless charging base according to an embodiment of the disclosure. Referring to FIGS. 1 to 3, an operation method 200 of the wireless charging base of this embodiment is suitable for supplying power to a plurality of electronic devices of different sizes (below, an electronic device 10 is used as an example, but is not limited thereto). The operation method 200 of the wireless charging base includes the following steps.

First, as shown in step 210 of FIG. 3, a wireless charging base 100 is provided, including a base body 110, a plurality of sensors 152, 154, 156, and 158 located on the base body 110, and a wireless coil 150 movably disposed in the base body 110, wherein the base body 110 includes a central area 111 and a plurality of peripheral areas 112 to 119 located outside the central area 111 (FIG. 2).

Then, as shown in step 220 of FIG. 3, at least one of these sensors 152, 154, 156, and 158 detects being covered when the electronic device 10 is placed on the base body 110 of the wireless charging base 100, wherein the at least one of these sensors 152, 154, 156, and 158 detecting being covered corresponds to at least one of these peripheral areas 112 to 119.

Next, as shown in step 230 of FIG. 3, the wireless coil 150 is placed in the central area 111, and a charging test is performed on the electronic device 10 to determine whether an output wattage of the wireless coil 150 exceeds a preset value. In this embodiment, the preset value is between a rated output wattage of the wireless coil 150 plus 0.35 to 0.5 watt. In one embodiment, the preset value is a rated output wattage of the wireless coil 150 plus 0.35 watt.

As shown in step 240 of FIG. 3, the wireless coil 150 starts charging the electronic device 10 in the central area 111 when the wireless coil 150 is located in the central area 111 and the output wattage does not exceed the preset value. In this embodiment, if the rated output wattage of the wireless coil 150 is 10 watts, and if the output wattage of the wireless coil 150 is 10.2 watts, this represents that the electronic device 10 corresponds well to the wireless coil 150, and therefore the wireless coil 150 does not need to output an excessively high wattage. Therefore, the wireless coil 150 may continue charging the electronic device 10 in the central area 111.

As shown in step 250 of FIG. 3, the wireless coil 150 is moved to the at least one of these peripheral areas 112 to 119 when the wireless coil 150 is located in the central area 111 and the output wattage exceeds the preset value, and the charging test is performed on the electronic device 10 to determine which of the at least one peripheral areas 112 to 119 in which the wireless coil 150 is located has the output wattage that does not exceed the preset value.

That is to say, when the wireless coil 150 is located in the central area 111 and the output wattage exceeds the preset value, this represents the electronic device 10 does not correspond well to the wireless coil 150, and therefore the wireless coil 150 requires outputting a higher wattage. Therefore, according to positions of the at least one peripheral area 112 to 119 corresponding to the sensors 152, 154, 156, and 158 detecting being covered, the controller 120 moves the central track 140 to dock with the corresponding peripheral areas 112 to 119 one by one, allowing the wireless coil 150 to move to the corresponding peripheral areas 112 to 119 so that the charging test is performed on the electronic device 10. Once finding the wireless coil 150 in one of the peripheral areas 112 to 119, the output wattage does not exceed the preset value, the finding is stopped.

Next, as shown in step 260 of FIG. 3, in the peripheral area 112 to 119 in which the output wattage of the wireless coil 150 does not exceed the preset value, the wireless coil 150 is made to charge the electronic device 10.

Therefore, the wireless charging base 100 of this embodiment may automatically adjust a position of the wireless coil 150. Regardless of whether a user places the electronic device 10 vertically or horizontally on the wireless charging base 100, the wireless charging base 100 may automatically adjust the wireless coil 150 to find an optimal charging position, so that the charging efficiency of wireless charging achieves an optimum, reducing a heat loss generated during charging.

More specifically, as shown in FIG. 1, if the electronic device 10 is placed in the lower left corner of the base body 110, the sensors 152, 158 are covered by the electronic device 10. The controller 120 first makes the wireless coil 150 charge the electronic device 10 in the central area 111. The controller 120 determines, according to whether the output wattage of the wireless coil 150 exceeds the preset value, whether the wireless coil 150 may well charge the electronic device 10 in the central area 111.

If the output wattage of the wireless coil 150 exceeds the preset value, this represents the wireless coil 150 cannot properly charge the electronic device 10 in the central area 111. The controller 120 controls the first motor 132 to rotate the gear set 134, causing the central track 140 to rotate and bridge to one of the peripheral tracks 141, 148, and 147. If first taking the peripheral track 141 as an example, the controller 120 controls the second motor 136 to move the wireless coil 150 from the central track 140 to the peripheral track 141, located in the peripheral area 112 (FIG. 2), and charge the electronic device 10 in the peripheral area 112.

Next, the controller 120 determines, according to whether the output wattage of the wireless coil 150 exceeds the preset value, whether the wireless coil 150 may well charge the electronic device 10 in the peripheral area 112. If the output wattage of the wireless coil 150 does not exceed the preset value, this represents the wireless coil 150 may well charge the electronic device 10 in this peripheral area 112, and then the charging continues.

Otherwise, the controller 120 controls the second motor 136 to move the wireless coil 150 back from the peripheral track 141 to the central track 140. The controller 120 then controls the first motor 132 to rotate the gear set 134, causing the central track 140 to rotate and bridge to the peripheral track 148. Next, the controller 120 controls the second motor 136 to move the wireless coil 150 from the central track 140 to the peripheral track 148, located in the peripheral area 119, and charge the electronic device 10 in the peripheral area 119.

Next, the controller 120 determines whether the wireless coil 150 may well charge the electronic device 10 in this peripheral area 119. If not, the wireless coil 150 is moved to the peripheral area 118 in the same way and charges the electronic device 10 in the peripheral area 118. Through the above way, the wireless charging base 100 may find the optimal charging position of the wireless coil 150.

Compared to the conventional charging pads, positions of coils are fixed, and charging compatibility thereof is poor. A user cannot know whether the electronic device 10 is placed in a correct position. The wireless charging base 100 of this embodiment may automatically move the wireless coil 150 to adapt to the position in which the electronic device 10 is placed. Since the wireless coil 150 automatically moves to a low power consumption position, a conventional situation, in which a power loss is caused due to inaccurate placement of the electronic device 10, is solved.

In summary, the central track of the wireless charging base of the disclosure is disposed in the base body and linked to the driving assembly to be rotatably disposed in the central area of the base body. These peripheral tracks are disposed in the base body and radially disposed on a periphery of the central area. The central track is driven by the driving assembly to dock with one of these peripheral tracks. The wireless coil is disposed in the base body, electrically connected to the controller, and linked to the driving assembly to move along the central track or one of these peripheral tracks. These sensors are disposed on the base body at equal intervals and electrically connected to the controller. Therefore, when the electronic device is placed on the base body of the wireless charging base, a charging test may first be performed on the electronic device in the central area through the wireless coil to determine whether the output wattage of the wireless coil exceeds the preset value. If not, this represents the wireless coil may directly charge in the central area. If yes, this represents the electronic device does not correspond well to the wireless coil, and therefore the wireless coil needs to output a higher wattage. Then, according to positions of peripheral areas corresponding to the sensors detecting being covered, the controller moves the central track to dock with the corresponding peripheral area, allowing the wireless coil to move to the corresponding peripheral area so that the charging test is performed on the electronic device. Therefore, the wireless charging base of the disclosure is applied to electronic products of different sizes.

What is claimed is:

1. A wireless charging base, comprising:
a base body, comprising a central area;
a controller, disposed in the base body;
a driving assembly, disposed in the base body and electrically connected to the controller;
a central track, disposed in the base body and linked to the driving assembly to be rotatably disposed in the central area of the base body;
a plurality of peripheral tracks, disposed in the base body and radially disposed on a periphery of the central area, wherein the central track is driven by the driving assembly to dock with one of the plurality of peripheral tracks;
a wireless coil, disposed in the base body, electrically connected to the controller, and linked to the driving assembly to move along the central track or the one of the plurality of peripheral tracks; and
a plurality of sensors, disposed on the base body at an equal interval and electrically connected to the controller.

2. The wireless charging base according to claim 1, wherein the base body is a rectangle, and the plurality of peripheral tracks extend toward four corners and four midpoints of four sides of the rectangle.

3. The wireless charging base according to claim 2, wherein each of the plurality of sensors is an optical sensor, and the plurality of sensors are disposed on the four sides or the four corners of the rectangle.

4. The wireless charging base according to claim 1, wherein the driving assembly comprises a first motor and a gear set, the gear set is linked to the first motor, the central track is linked to the gear set, and the central track rotates through the gear set.

5. The wireless charging base according to claim 1, wherein the driving assembly comprises a second motor, linked to the wireless coil to drive the wireless coil to move along the central track or the one of the plurality of peripheral tracks.

6. An operation method of a wireless charging base, adapted to supply a power to an electronic device, comprising:
providing the wireless charging base, comprising a base body, a plurality of sensors located on the base body, and a wireless coil movably disposed in the base body, wherein the base body comprises a central area and a plurality of peripheral areas located outside the central area;
at least one of the plurality of sensors detecting being covered when the electronic device is placed on the base body of the wireless charging base, wherein the at least one of the plurality of sensors detecting being covered corresponds to at least one of the plurality of peripheral areas;
placing the wireless coil in the central area, and performing a charging test on the electronic device to determine whether an output wattage of the wireless coil exceeds a preset value;
the wireless coil starting charging the electronic device in the central area when the wireless coil is located in the central area and the output wattage does not exceed the preset value;
moving the wireless coil to the at least one of the plurality of peripheral areas and performing the charging test on the electronic device when the wireless coil is located in the central area and the output wattage exceeds the preset value, so as to determine which of the at least one of the plurality of peripheral areas in which the wireless coil is located has the output wattage that does not exceed the preset value; and
in the peripheral area in which the output wattage of the wireless coil does not exceed the preset value, the wireless coil charging the electronic device.

7. The operation method of the wireless charging base according to claim 6, wherein the preset value is between a rated output wattage of the wireless coil of +0.35 to 0.5 watt.

8. The operation method of the wireless charging base according to claim 6, wherein when finding in the which one of the at least one of the plurality of peripheral areas where the wireless coil is located the output wattage of the wireless coil does not exceed the preset value,
once finding the one of the at least one of the plurality of peripheral areas in which the output wattage of the wireless coil in does not exceed the preset value, stopping finding.

9. The operation method of the wireless charging base according to claim 6, wherein the wireless charging base comprises:
a driving assembly, disposed in the base body;
a central track, disposed in the base body and linked to the driving assembly to be rotatably disposed in the central area of the base body; and
a plurality of peripheral tracks, disposed in the base body and radially disposed on a periphery of the central area, wherein the central track is driven by the driving assembly to dock with one of the plurality of peripheral tracks, and the wireless coil is linked to the driving assembly to move along the central track or the one of the plurality of peripheral tracks.

10. The operation method of the wireless charging base according to claim 9, wherein a number of the plurality of peripheral areas corresponds to a number of the plurality of peripheral tracks.
